(19) United States
(12) Patent Application Publication
(10) Pub. No.: US 2009/0187979 A1
(43) Pub. Date: Jul. 23, 2009

(54) METHOD AND APPARATUS FOR GLOBAL UNIQUE IDENTIFIER, INCLUDING ID DATABASE

(76) Inventor: Gil Sever, Rosh-Haayin (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/355,761

(22) Filed: Jan. 17, 2009

Related U.S. Application Data
(60) Provisional application No. 61/022,322, filed on Jan. 19, 2008.

(51) Int. Cl. H04L 9/32

(52) U.S. Cl. 726/5

(57) ABSTRACT

An entity can request the generation of a unique identifier to serve as a common identifier for the entity immune to changes in the entities contact information. A data base entry indexed at least in part by the unique identifier can be created for housing further contact information for the entity. The unique identifier can remain a constant focal point for contacting the entity or obtaining contact information about the entity. The entity can update contact information in the data base entry and as such, the unique identifier can be used to access current contact information.

### CROSS-REFERENCE TO RELATED APPLICATIONS

This application is a United States non-provisional application filed pursuant to Title 35, United States Code §100 et seq. and 37 C.F.R. Section 1.53(b) claiming priority under Title 35, United States Code §119(e) to U.S. provisional application No. 61/022,322 filed on Jan. 19, 2008 which is hereby incorporated by reference in its entirety.

### BACKGROUND

The present invention describes a method for generating, providing and using a unique identification for different entities, including but not limited to enterprises, corporations, governmental agencies, partnerships, shops, individuals and more. Such unique identities will allow these entities to use a unique and clear identification that will clearly and particularly identify the entity and separate the entity from other entities. Further, the unique identity accompanies the entity for a long period of time, hopefully even for their entire life, and will help the entity to (a) improve and ease the storing, finding, and updating relevant information that is required to represent them, (b) help other people or entities to find the entity or interface with the entity, may it be for the entity's own use or as a form of relaying current and reliable information regarding the entity to others.

A person or non-human legal entity (such as corporations, agencies, partnerships etc.) uses a certain identifier to identify them. This identifier may be the name of a person, the name of a corporation and so on. Many times this identifier isn't unique, for example there might be several people sharing the same given name and family name.

There also might be two corporations with the same name (in different states for instance). Two different branches of the same corporation may find it difficult to differentiate themselves, and so on.

A person or a non-human legal entity also has some characteristics and descriptive information that accompanies it or that is associated with it. As non-limiting examples, such information can include parameters such as contact information (e.g. e-mail address or several of them, telephone number(s), cellular telephone number(s), physical address, addresses of all branches, names of branches etc.). Another type of information, which has personal or confidential nature, includes parameters like bank account numbers, passwords that are being used for various operations and more.

While many entities would like their identifications to remain unique and unchanged for the duration of their lives, the entity's information may vary over time. For instance, people change their address, their telephone number and more, corporations add or eliminate branches, change branches addresses etc.

As mentioned above, information gathered by entities can be divided roughly into two categories: information of personal/confidential nature, which is necessary only to the entity itself, and information that can be made public, for it is necessary for others.

The first type of information, that which has private characteristics, is mostly comprised of data the entity requires for its own use: social security number (for people) or company number, corporate ID or corporate tax ID (for companies), bank account numbers and the branches in which those accounts are run, credit card numbers, usernames and passwords for various software and e-mail accounts, nicknames and passwords for chat rooms and internet communities and so on.

The second type of information is comprised of data the entity wishes to publicize or share with others: the entity's home, office and mobile/cellular telephone numbers, current home/business address, e-mail address, line of business, authorized signers (in corporations) and so on.

Information of the first type is stored in various locations, both physical and computerized. Some people save such information on their mobile telephone's memory or other portable storage and/or communication devices; others use an organizer, while some just keep a piece of paper inside their wallet. Whichever method is being used, the information is almost never stored fully in one place, and often has no back-up, incase the organizer is misplaced or that piece of paper vanishes.

Information of the second type is usually better organized and protected, when it comes to businesses, because it is in the business's best interest to keep it as accessible as possible. Such information can usually be found printed on business cards, and in yellow pages and other business guides, including on-line ones. Information of the second type regarding people who have no business interest in publicizing their contact numbers and address can usually be found in local telephone directories and white pages.

All is well until a change needs to be made in the information which has been made public. For instance, a shop has opened a second branch in a different location and would like its costumers to know about it; a person moved to another state, changed his/her name and would still like high schools friends to be able to track him/her down.

Making such changes public can be quite difficult and entails much bureaucracy, whether it be contacting different directories and asking them to change the listings, or calling each contact in a person's address book and letting them know about the change. Such efforts can be time consuming and also frustrating, for they cannot guarantee a 100% success rate.

Most businessmen give out business cards as a means of making sure their potential customers can reach them at any given time. However, the information on business cards is valid and current only at the time the card is printed—a potential customer has no way of knowing if the contact information changed since he received the card.

What is needed in the art is a technique for creating an entity identification that not only uniquely identifies the entity, but that can preserve the good will that is generated through the use of the identifier and thus, maintain the ability to be contacted well into the future regardless of status changes or other information changes for the entity.

### BRIEF SUMMARY

Various embodiments of the present invention operate to solve the above-described needs in the art, as well as other needs in the art by providing one or more of the following features or aspects that are presented in more detail in the detailed description.

One aspect of various embodiments of the invention may be to provide a simple method to allocate a unique identifier (which will be referred to herein as a “unique ID”) to each entity, which can be used by that entity for a pro-longed period of time. Another aspect of various embodiments may be to provide a simple way for such entity to create a virtual database or record, containing each and every piece of information valuable to that entity. Another aspect of various embodiments of the invention may be to provide a simple method to back-up and protect that information so that it won't get lost or tampered with by others. Another aspect of various embodiments of the invention may be to provide a simple method to allow each entity to update and edit its information record at any given time, making the ID database fully up-to-date at any time. Another aspect of various embodiments of the invention may include a simple method to avoid the need to update various databases or guides about changes in address, contact information etc. Yet another aspect in various embodiments of the invention may include a simple method to allow each entity to determine what type of user or which specific users will be permitted to view each parameter and information field about that entity.

Various embodiments of the present invention may also employ or implement a variety of other features or aspects, including the above-described aspects either alone or including one or more other aspects, or including other aspects, such as but not limited to: (1) requiring the authentication of the identity of the creator of a unique ID before actually allocating a unique ID; (2) allowing entities to create multiple unique IDs for different purposes (for example, a public unique ID for information the entity wants to publicize, and a private unique ID, possibly with a non-characteristic or a non-significant name, so that action preformed under that unique ID won't be automatically liked to the user); (3) giving out keys alongside the unique identifier, each key signifying a different viewing authorization; (4) creating an ID search engine, permitting users to track down IDs of companies/persons even if these entities didn't give their unique ID directly to the users, and allowing these users to view basic information regarding those entities; (5) creating a hierarchy and/or connection between two or more unique IDs, so that one is a “daughter listing” of the other (for instance, the headquarters of a corporation may be the highest on such hierarchy, and other branches will be linked to the headquarters' unique ID and listed below it, though users may access the branches' ID separately); (6) allowing entities to limit or reduce the number of e-mail addresses they use, and potentially even telephone numbers, by using the “unique ID” as the main identifier through which the user can be accessed, thus saving the need to create multiple e-mail addresses for different purposes or because one of the addresses isn't relevant anymore (due to a change of employer etc.). With regards to this final aspect, a possible embodiment of this aspect may be comprised of creating a permanent e-mail address and directing all correspondence from that address to the current e-mail account the entity is using. The same can be done in the area of telephony.

These embodiments, aspects and features will be more fully appreciated by reading the following detailed description and claims, along with the figures provided.

### BRIEF DESCRIPTION OF THE SEVERAL VIEWS OF THE DRAWING

FIG. 1 is a flow chart diagram presenting an embodiment of a process for purchasing and maintaining a unique ID.

FIG. 2 is a block diagram that illustrates several of the operation and output possible from various embodiments of the present invention in response to generating a unique ID.

FIG. 3 is an exemplary screen diagram illustrating the structure of the basic format in an exemplary unique ID database.

FIG. 4 is a rendition of a typical business card that can include information generated from various embodiments of the present invention.

FIG. 5 is a diagram illustrating the structure and data entered in a basic database entry for a unique ID in an exemplary embodiment of the present invention.

FIG. 6 illustrates the structure of customized database entry that includes personal information that can be protected and made to be accessible only to authorized users.

FIG. 7 is a relationship structure showing a hierarchy and a linkage between entities. In the illustrated embodiment, an accounting firm 702 is shown with a headquarter 704.

FIG. 8 is a block diagram illustrating exemplary components that may be included in an embodiment of the invention.

FIG. 9 is a flow diagram illustrating exemplary steps that may be processed in an exemplary embodiment of the invention.

### DETAILED DESCRIPTION OF EMBODIMENTS OF THE INVENTION

The present invention, as well as features and aspects thereof, is directed towards generating unique identifiers for a requesting entity and maintaining a database entry for the entity that is accessible by the entity or others trying to contact the entity. Various features and aspects associated with this capability may be included in the various embodiments of the invention.

One embodiment that incorporates several features and aspects of the present invention is in the form of a website. In this embodiment, people and/or companies and/or processes may log into the website and obtain or purchase a unique identifier. The unique ID may simply be a string of alphanumerical characters, though other embodiments might be used in addition. The unique ID will serve that purchaser for the period of time listed in the contract between the two parties, preferably for a lifetime. Upon purchase, the entity will receive a password for authentication. After obtaining a unique ID, an entity may enter the ID database and start creating personal data records, which will be comprised of different parameters such as telephone numbers, addresses, bank account numbers etc.

Typically, the data records may contain a few standard parameters which can be filled out by the entity, thereby forming a basic structure for the database. Some of the standard fields might be mandatory. Aside from the standard fields, the entity will also have an opportunity to add fields of it's own, thus personalizing the database. The entity may enter as many entries for each parameter as desired.

Different levels of authorization will enable each entity to determine what type of user or which specific users will be permitted to view each parameter of information about that entity. These authorizations can range from having data which can be open to any user who may inquire about the entity, to having layered access for various different fields divided into categories, where each category may require the use of a different password.

Once the record is formed for the first time, the entity may access it at any given time and update or change the data listed within it.

The unique ID may serve the entity from that point on as its main form of identification. It may be printed on business or personal cards, it may be advertised in newspapers or websites, all in accordance with the occupation of the entity and its desire to provide public access to any of its information.

Advanced options can include the possibility to allocate a special access key to each level of viewing authorization. Thus, a businessman will give out business cards with a certain access key, permitting potential clients to view contact data and other relevant details, and may also give out another access key to his accountant, permitting him to view financial information etc.

Advanced options can also include allowing entities to create multiple unique IDs for different purposes. This option can be used by entities wishing to separate their business contacts from their personal ones. In addition, this option can be used by those who wish not to disclose their actual identity to all users, yet need to maintain a public page due to their line of business. As an example, suppose a user creates to unique IDs. The two IDs may include an openly publicized and recognizable unique ID and a confidential unique ID. The two IDs, the one with the indicative or recognizable name and that with the random or non-indicative (confidential unique ID) can be linked together or possibly joined into a single entity.

Advanced options can also include the possibility of entity-linkage, allowing hierarchies to be created. Creating links between such entities will require the consent of both entities, unless one is the “creator” of the other, and has full access to all of the information in its record. A hierarchy can be formed between different branches of the same company or between family members, groups, organizations, friends, etc.

Advanced options can also include the requirement to authenticate the identity of the creator of a unique ID before actually allocating a unique ID.

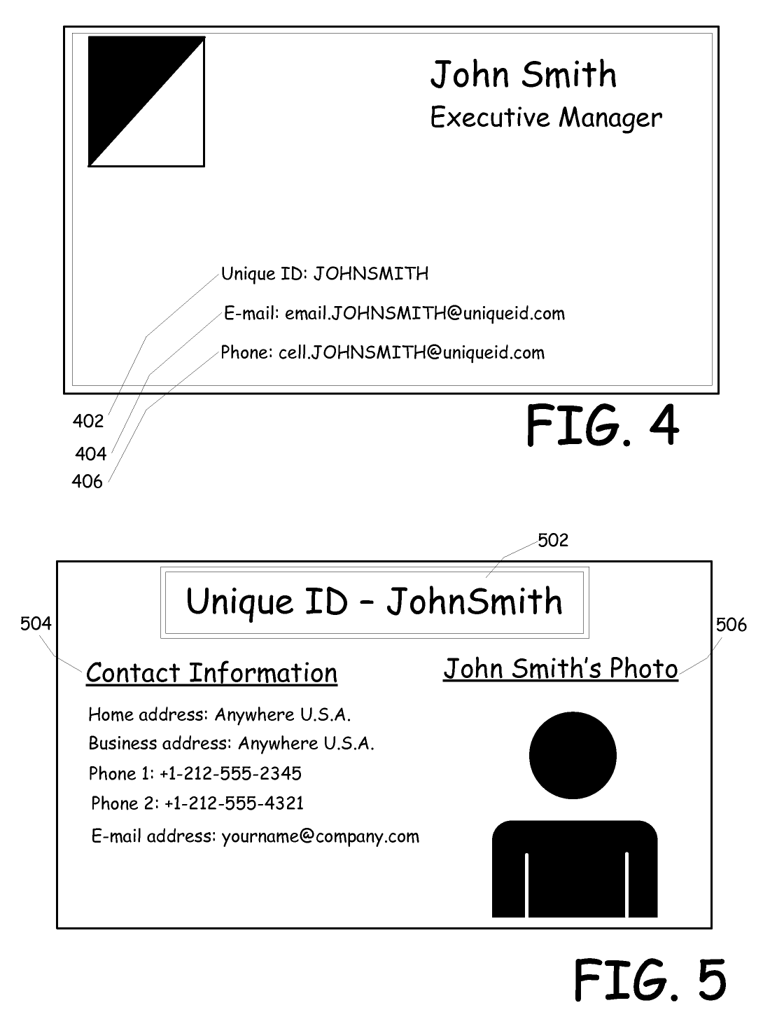

Finally, advanced options can include using the “unique ID” as the main identifier through which the user can be accessed, thus saving the need to create multiple e-mail addresses for different purposes or because one of the addresses isn't relevant anymore. A possible embodiment of this option will be comprised of creating a permanent e-mail address and directing all correspondence from that address to the current e-mail account the entity is using. The permanent e-mail address might belong to the unique ID domain (as shown in FIG. 4). The same can be done in the area of IP telephony.

Overall, the various embodiments of the present invention can operate to improve the ease, reliability and safety of finding and contacting people and organizations (entities), and sharing current public and private information between different entities. The invention will help entities to store, update and maintain personal, contact, location, and business information on-line, while providing a unique method of identification that is long lasting and efficient. Furthermore, embodiments of the present invention may operate as a method and/or an apparatus that simplifies the allocation of such identification and the attribution of information to that identification.

Turning now to the figures, exemplary embodiments of the present invention are described in more detail The purpose of the drawings is to describe an exemplary embodiment and not for production. Therefore features shown in the figures are chosen for convenience and clarity of presentation only.

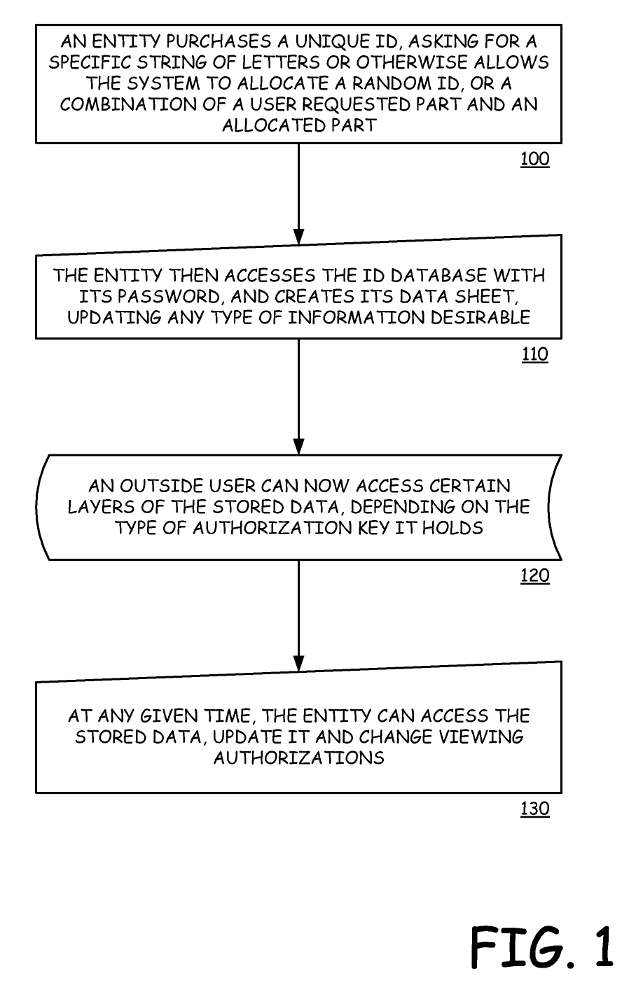

FIG. 1 is a flow chart diagram presenting an embodiment of a process for purchasing and maintaining a unique ID. Initially, an entity purchases a unique ID 100. Depending on the embodiment or user selections, the user may ask for a specific string of characters or may allow the system to allocate a random string as the unique ID. Further, embodiments may also employ a combination of both of these techniques by creating a unique ID that is formed partially from a user requested string of characters and a generated set of characters. Thus, the unique ID may consist of a user requested part and a allocated or generated part.

The entity may then access an ID database with an assigned or selected password to create a data record or data sheet 110. The entity may provide or update any type of information desired. At this point, an outside user or other entity may now access certain layers of the stored data in the entities data sheet 120. Such access may depend on the type of authorizations granted by the creating entity and/or the type of authorization key or password the accessing entity holds.

Subsequently, the entity may access the stored data sheet or records to update the information, change or create viewing authorization requirements, etc 130.

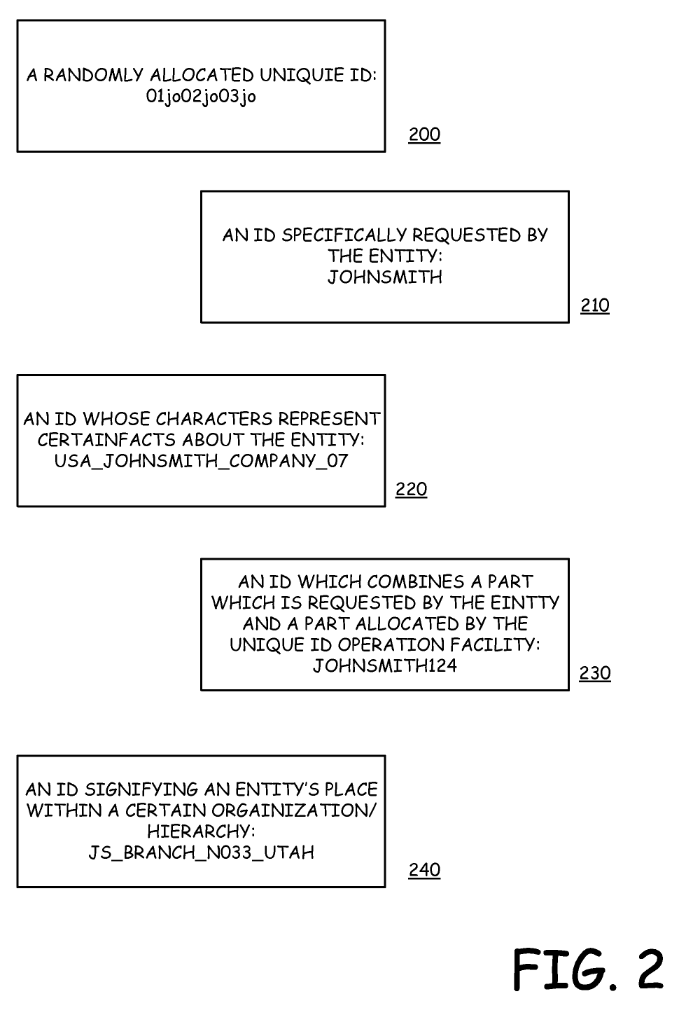

FIG. 2 is a block diagram that illustrates several of the operation and output possible from various embodiments of the present invention in response to generating a unique ID. Embodiments of the present invention may use one or more of the illustrated formats. One output form shows a random allocation of a unique ID 200. This aspect of embodiments of the invention may be selected by entities desiring to create a unique ID that will not be associated with them instantly. Another output form shows an example of unique ID requested specifically by the entity wherein the entity provides the desired string of characters 210. This aspect of embodiments of the invention allows a user to create a unique ID that clearly identifies or is associated with the entity. Another output form shows an example of a unique ID that is created by entity provided input but, that operates to show further identifying information about the entity, such as the country, affiliated company, etc. 220. Another output form shows an example of a unique ID which combines an entity requested portion and a portion that is allocated by the unique ID operation facility 230. This aspect of embodiments shows that the unique ID can represent certain facts regarding the entity but include further elements to provide uniqueness. Yet another output form for embodiments of the invention illustrates a unique ID for an entity who is part of a larger corporation or hierarchy 240.

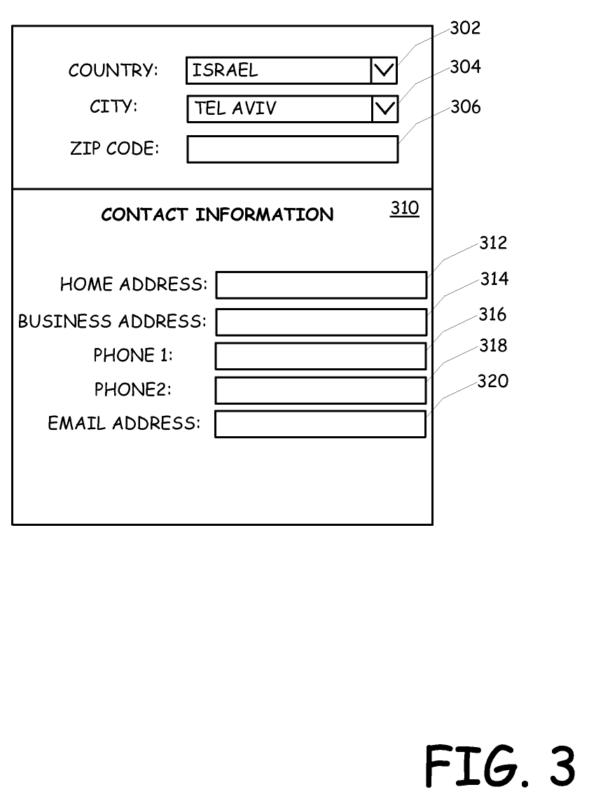

FIG. 3 is an exemplary screen diagram illustrating the structure of the basic format in an exemplary unique ID database. In the illustrated embodiment, the entity is presented with an information request screen to allow the entity to select and/or enter various types of information. It should be appreciated that this illustration is provided solely as an example and those skilled in the art will appreciate that any number of information fields as well as presentations and interfaces for obtaining the information could be employed in various embodiments of the present invention. The illustrated embodiment includes a pull down menu 302 for the entity to select a country and a pull down menu 304 for the entity to select a city. A Zip code field 306 is also provided which can be automatically filled in based on the country and city, or manually entered by the entity.

Further, a contact information window 310 is also provided for the entity to enter various contact information parameters. The illustrated embodiment includes a home address 312, a business address 314, a first telephone number 316, a second telephone number 318 and an email address 320.

FIG. 4 is a rendition of a typical business card that can include information generated from various embodiments of the present invention. In the illustrated embodiment, the rendition of the business card includes the entity's name and position, along with a company logo or other identifying indicia as is typical on most business cards. However, the business card also is shown as including an entry that identifies the unique ID of the entity JOHNSMITH 402, an email address incorporating the unique identity email.JOHNSMITH@uniqueid.com 404 and a telephone access identifier that also includes the unique identity cell.JOHNSMITH@uniqueid.com 406.

FIG. 5 is a diagram illustrating the structure and data entered in a basic database entry for a unique ID in an exemplary embodiment of the present invention. The database entry is identified by the unique ID as the key—here the unique ID is shown to be JohnSmith 502. The database entry includes contact information 504 and a photograph selected by the entity 506. The contact information included in the illustrated embodiment includes the home address, business address, two telephone numbers and an email address, although those skilled in the art will appreciate that any of a variety of information and combinations could be used in various embodiments.

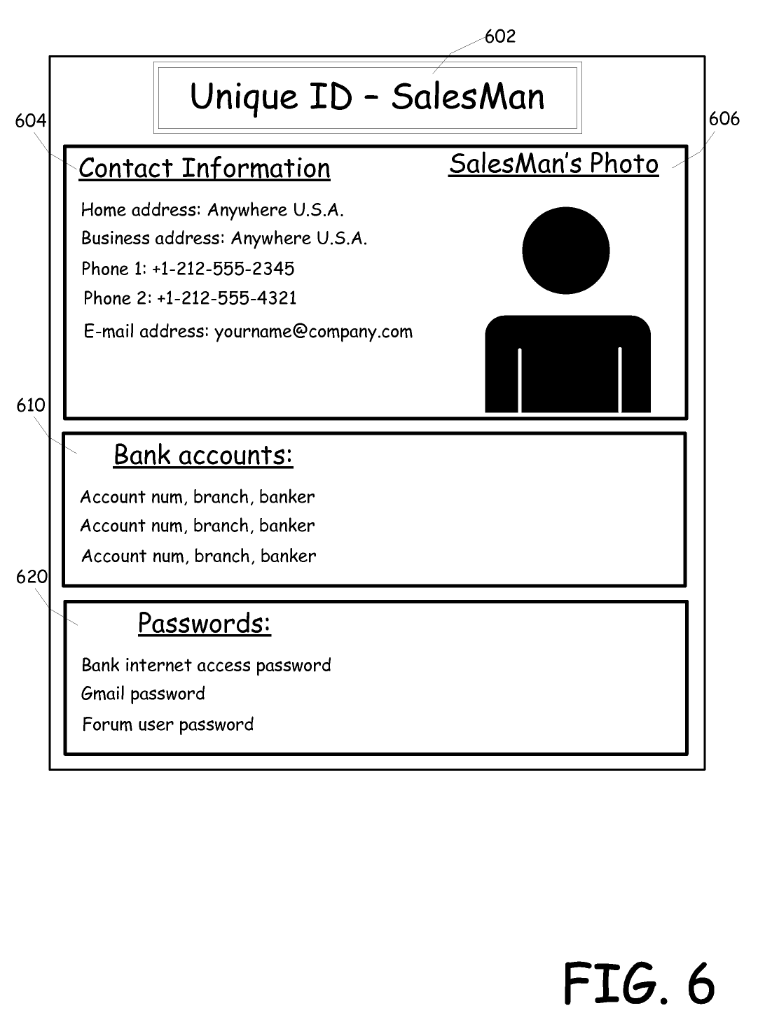

FIG. 6 illustrates the structure of customized database entry that includes personal information that can be protected and made to be accessible only to authorized users. The database entry is identified by the unique ID as the key—here the unique ID is shown to be SalesMan 602. Similar to the database entry illustrated in FIG. 5, this customized database entry includes contact information 604 and a photograph selected by the entity 606. The contact information included in the illustrated embodiment includes the home address, business address, two telephone numbers and an email address, although those skilled in the art will appreciate that any of a variety of information and combinations could be used in various embodiments. However, the illustrated database entry in FIG. 6 also is shown as including two classes of confidential information that can be protected from access. These classes include bank accounts 610 and passwords 620. For the bank accounts information, each bank account is shown as including an account number, a branch and a banker identification. The password information 620 list a description of the purpose of the password and then the password value.

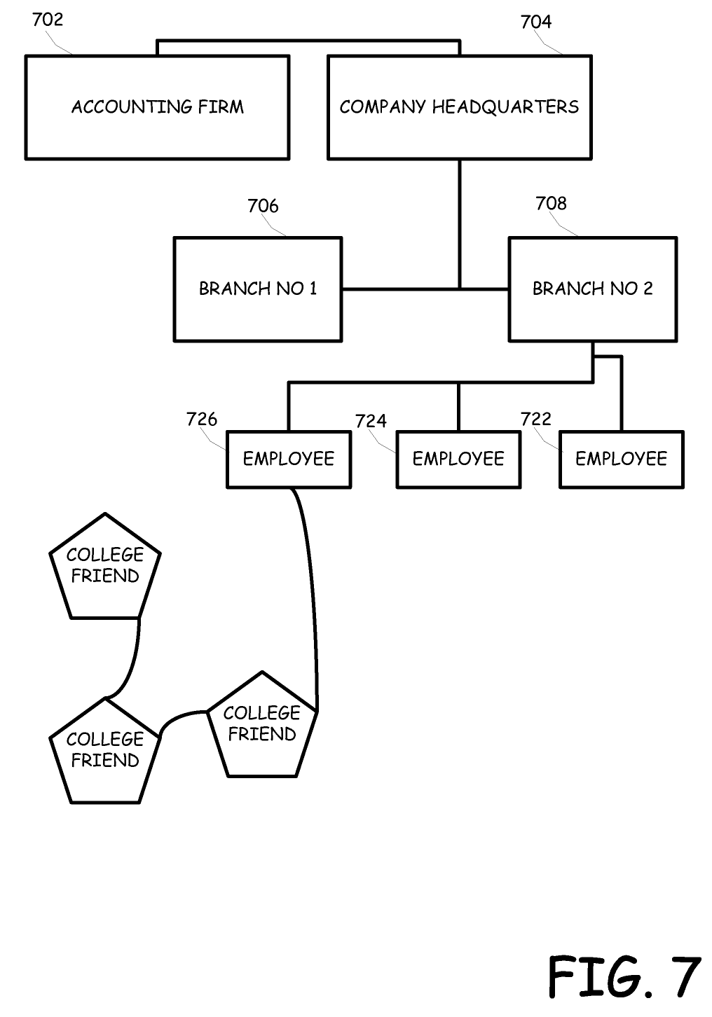

FIG. 7 is a relationship structure showing a hierarchy and a linkage between entities. In the illustrated embodiment, an accounting firm 702 is shown with a headquarter 704. The illustrated company is shown to include two branches, branch number 1 706 and branch number 2 708. Further, the branch number 2 708 is shown as listing three employees 722, 724 and 726. Given the illustrated structure, it should be appreciated that unique IDs can be generated for the accounting firm, the company headquarters, the two branches and the three employees. In addition, the unique IDs for the employees may include branch information and/or company information. Further, the unique IDs for the branches may also include company headquarter information. The unique ID for the accounting firm may include information to identify the company headquarters as well. In addition, each of the unique IDs may include user provided data, generated data or a combination of both. It should be appreciated that embodiments of the invention that generate the entire unique ID may also provide common strings to show relatedness among entities. For example, a generated unique ID for the company headquarters 702 may be 75UMT002 for example. Further, branch number 1 706 may have a unique ID of 75UMT00200A and branch number 2 708 may have a unique ID of 75UMT002TX1. Both of these unique IDs show a relationship to the company headquarters without disclosing the company per se. This could similarly be applied to the employees.

Finally, FIG. 7 also illustrates that one of the employees 726 is also linked to three college friends. This linkage may represent that the college friends have authorization to access certain types of information made available by the employee.

Advantageously, the various embodiments of the invention operate to generate unique IDs that can be used by an entity on a perpetual basis. There is an ever expanding set of applications and uses for user identifications. For instance, an entity may have a user identification for email, web addresses, face book, twitter, friend finder, myspace, as well as a plethora of other applications, social media ventures or the like. Embodiments of the present invention may operate to access all possible forums in selecting and assigning a unique ID, thus obtaining a unique ID that the user can employ in a variety of settings. Further, each of the various applications that require unique IDs may access the database generated by embodiments of the present invention to provide feedback to users when attempting to select a unique ID. Further, once a unique ID is generated, various embodiments of the invention may automatically access other arenas to also preserve the entity's rights to use that unique ID.

Another aspect of the various embodiments of the present invention is to server as a central lookup point for obtaining contact information. For instance, the email address and/or telephone number sequence shown in FIG. 4 could be used to access a database to obtain the contact information for an entity as it changes. By maintaining changes in the database, the entity can update contact information that remains accessible by the unique ID. As an example, an email sent to email.JohnSmith@uniqueid.com may result in a return email that lists the publically available contact information for John Smith.

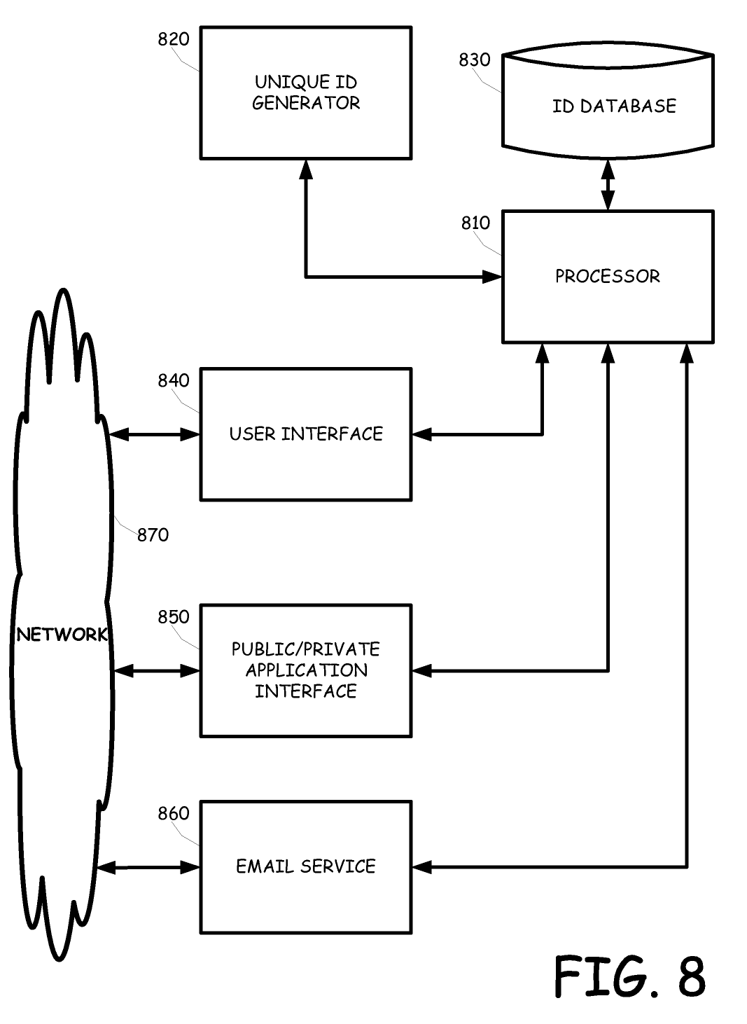

FIG. 8 is a block diagram illustrating exemplary components that may be included in an embodiment of the invention. It should be realized that the illustrated components are simply provided to illustrate a functional breakdown of various components in an exemplary embodiment of the invention and that not all embodiments will require each of the illustrated components. Further, although the components are illustrated as separate blocks, it will be appreciated that the various functionalities could be combined or broken down in a variety of manners and as such, this is a functional block diagram and not necessarily a system component diagram.

The illustrated functional components include a processor 810, a unique ID generator 820, and ID database 820, a user interface 840, a public application interface 850 and an email service 860. Further, a network cloud 870, which could be any local or global network, such as the Internet is also illustrated as being interfaced to by the user interface 840, a public application interface 850 and an email service 860.

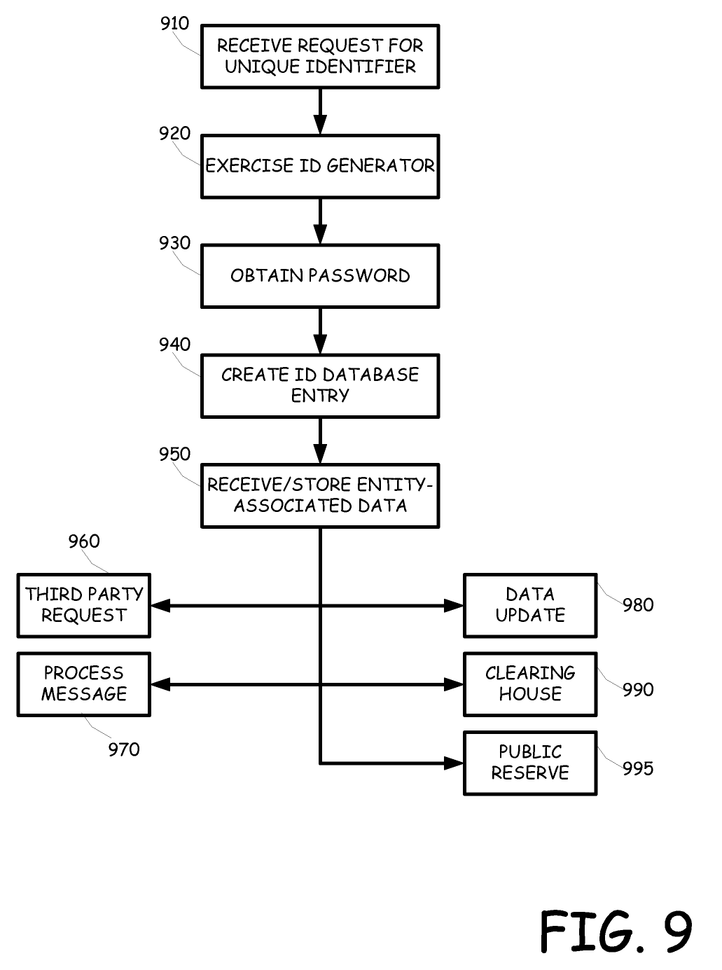

FIG. 9 is a flow diagram illustrating exemplary steps that may be processed in an exemplary embodiment of the invention. The steps illustrated in FIG. 9 are described in conjunction with the functional components illustrated in FIG. 8. It should be appreciated that the exemplary steps illustrated in the flow chart are not all necessary in all embodiments of the invention and do not necessarily have to flow in the order shown.

Initially, the processor 810 receives a request from an entity over the user interface 840 for the generation of a unique identifier 910. In response, the processor 810 then exercises the unique ID generator 820 to have a unique identifier generated 920. The processor 810 then obtains a password 930 and creates an entry in the ID database 830 for the generated unique identifier 940 and associates the password with that entry. It should be appreciated that the entity may be prompted through the user interface 840 to provide a password or, the processor 810 may automatically generate a password and provides the same to the entity over the user interface 840. In either case, the password is then subsequently required for the entity to gain access to the entry in the ID database 830. The processor 810 may then receive and store entity-associated data into the entry in the ID database 830. It should be appreciated that the entity-associated data may be entirely provided by the entity over the user interface 840, may be pulled by the processor 810 from another source, generated by the processor 810 or a combination of any of these techniques.

Once the entity has a unique identifier and an entry is stored in ID database 830 for the unique identifier, a variety of events may occur. For instance, a third party may make a request over the user interface 840 for information related to the unique identifier 960. As previously described, the entity may set up various authorization criteria for the entire entry or for various portions of the entry. Each authorization may include a separate pass code or other authentication procedure that the third party must satisfy prior to gaining access to the data. Once access is gained, the processor 810 can provide the data to the third party over the user interface 840, via an email over the email service 860, or otherwise.

In addition, a message for the entity may be received via the user interface 840 or the email service (processor or server) 860 that is directed toward the entity 970. As previously described, this could be an email or message sent to a unique email address generated by the processor 810 or may the unique identifier may serve as the unique email address itself. Alternatively, the email may be sent to a common generic email address with the unique identifier in the subject, heading or body of the message. In this case the processor can parse the message to identify the unique identifier and dispose of the message accordingly. In one embodiment, disposing of the message may include looking up an email address for the entity, or some other address (such as a fax number, FACEBOOK ID, TWITTER ID, etc.) and forward the message accordingly. Alternatively, the email may be stored for the entity to access at a later time or the system may send a notice to the entity to indicate that an email is waiting.

Another action may include the entity regaining access to the entry in the database by again logging on through the user interface 840 with the password 980. In this situation, the entity can modify, change, delete or add entity-associated data to the entry and/or delete the entry altogether.

Embodiments of the invention may also operate as a clearing house 990. As a clearing house, an embodiment may be accessible by public applications (such as TWITTER, FACEBOOK, YAHOO MAIL, GOOGLE MAIL, HOTMAIL, etc.) through the public application interface 850 when a user is attempting to select a user id. The public application, or even private applications, may access the system and have a requested user id checked against the ID database 830 to verify that no other entities have already reserved use of the name. In addition, the system may operate as a centralized generator for such applications. For instance, if a unique identifier has already been allocated, the processor 810 may request the ID generator to generate one or more alternate unique identifiers that can be presented to the requesting party for selection.

Upon being selected, the application can again notify the system and the name can be reserved in the ID database 830.

The system may operate to access public and/or private applications through the public application interface 850 as part of the unique identifier generation process. The processor 810 may query other systems prior to assigning a unique identifier to ensure that no one else has reserved and is using the identifier in the checked applications. If the identifier is in use, alternate unique identifiers may be generated.

The system may also provide a public reserve function 995. This feature would allow the system, once a unique identifier is selected, to access public and/or private applications and reserve the unique identifier for the requesting entity.

In the description and claims of the present application, each of the verbs, “comprise” “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that is provided by way of example and is not intended to limit the scope of the invention. The described embodiment comprises different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for allocating a unique identification to an entity, the method comprising the steps of:
receiving a request from an entity for a unique identifier;
generating a unique identifier and password;
creating a unique identifier entry into an ID database;
providing access, by entry of the password, to allow the entity to enter entity-associated data into the entry in the ID database associated with the unique identifier and allowing the entity to provide access rights associated with one or more entity-associated data entries;
receiving a request from a third party to access entity-associated data for the entity;
requesting authorization credentials from the third party; and
verify the authorization credentials and grant access only to entity-associated data entries that are accessible based on the received authorization credentials.

2. The method of claim 1, further comprising the steps of:
receiving an access request from the entity to access the ID database;
receiving an authorized password from the entity; and
accepting updated entity-associated data into the entry in the ID database associated with the unique identifier.

3. The method of claim 1, wherein the step of generating a unique identifier further comprises the steps of:
receiving unique identifier input from the entity; and
generating the unique identifier based at least in part on the unique identifier input.

4. The method of claim 1, wherein the step of generating a unique identifier further comprises the steps of:
receiving unique identifier input from the entity;
generating a random string of characters; and
generating the unique identifier based at least in part on the unique identifier input and the random string of characters.

5. The method of claim 1, wherein the step of generating a unique identifier further comprises the steps of:
generating a random string of characters; and
generating the unique identifier based at least in part on the random string of characters.

6. The method of claim 1, wherein the step of generating a unique identifier further comprises the steps of:
receiving unique identifier input from the entity;
generating the unique identifier based at least in part on the unique identifier input and one or more entity-associated data entries to create an hierarchical unique identifier that associates the entity with one or more other entities.

7. The method of claim 1, wherein the step of generating a unique identifier further comprises the steps of:
accessing one or more public applications requiring a user identifier; and
selecting a unique identifier that is not currently in use by the one or more public applications.

8. The method of claim 7, further comprising the steps of:
registering the unique identifier with the one or more public applications if the unique identifier is available.

9. The method of claim 1, further comprising the steps of:
receiving a request from a third party regarding the availability of a user identifier;
examining the ID database to determine if a unique identifier that matches the request user identifier exists;
providing results to the third party regarding the availability of the unique identifier for use as a user identifier.

10. The method of claim 1, further comprising the steps of:
generating an email address based on the unique ID;
receiving an email message directed to the generated email address;
accessing the ID database based on the unique identifier to obtain a current email address; and
forwarding the email message to the current email address.

11. The method of claim 1, further comprising the steps of:
generating an email address based on the unique ID;
receiving an email message directed to the generated email address;
accessing the ID database based on the unique identifier to obtain entity-associated data authorized to be accessed by means of an email; and
replying to the email with the entity-associated data.

12. A system for allocating and managing unique identifications for entities, the system comprising:
a unique ID generator;
an ID database;
a user interface; and
a processor that is operable to:
receive a request from an entity for a unique identifier over the user interface;
exercise the unique ID generator to generate a unique identifier;
obtain a password to provide access to the ID database;
access the ID database to create a unique identifier entry into an ID database;
provide access through the user interface, upon reception of the password, to allow the entity to enter entity-associated data into the entry in the ID database associated with the unique identifier and allowing the entity to provide access rights associated with one or more entity-associated data entries;
receive a request through the user interface from a third party attempting to access entity-associated data for the entity;
request authorization credentials from the third party through the user interface; and
upon verifying the authorization credentials, grant access only to entity-associated data entries in the ID database that are accessible based on the received authorization credentials.

13. The system of claim 12, further comprising an email service, wherein the processor is further operative to:
generate an email addressed based at least in part on the unique identifier;
receiving an email directed towards the generated email address;
access the ID database to obtain entity-associated data for the unique identifier; and
dispose of the email message.

14. The system of claim 13, wherein the processor is operative to dispose of the email message by forwarding the email message to an email address obtained from the ID database.

15. The system of claim 13, wherein the processor is operative to dispose of the email message by replying to the email message and including the obtained entity-associated data for the unique identifier.

16. The system of claim 12, further comprising a public application interface, and wherein the processor is further operative to:
query one or more public applications through the public application interface to determine if the generated user identification has been previously allocated; and
exercise the unique ID generator to generate an alternate unique identifier.

17. The system of claim 12, further comprising a public application interface, and wherein the processor is further operative to:
query one or more public applications through the public application interface to determine if the generated user identification has been previously allocated;
exercise the unique ID generator to generate an alternate unique identifier; and
to reserve the unique identifier for the entity in the one or more public applications.

18. The system of claim 12, further comprising an interface for public applications, and wherein the entity requesting the unique identifier is a public application.

19. A method for allocating a unique identification to an entity, the method comprising the steps of:
receiving a request from an entity for a unique identifier;
generating a unique identifier and password;
creating a unique identifier entry into an ID database;
providing access, by entry of the password, to allow the entity to enter entity-associated data into the entry in the ID database associated with the unique identifier and allowing the entity to provide access rights associated with one or more entity-associated data entries;
subsequently, providing further access, by entry of the password, to allow the entity to update the entity-associated data; and
in response to an authorized query identifying the unique identifier, provide access to the entity-associated data based on the authorization.

20. The method of claim 19, further comprising the steps of:
receiving a communication for the entity that includes the unique identifier; and
based at least in part on the unique identifier, disposing of the communication by redirecting the communication in accordance with the entity-associated data.
